(19) United States
(12) Patent Application Publication
(10) Pub. No.: US 2022/0414894 A1
(43) Pub. Date: Dec. 29, 2022

(54) OBJECT TRACKING BASED ON FLOW DYNAMICS OF A FLOW FIELD

(71) Applicant: HEWLETT-PACKARD DEVELOPMENT COMPANY, L.P., Spring, TX (US)

(72) Inventors: Yang Lei, Palo Alto, CA (US); Viktor Shkolnikov, Palo Alto, CA (US)

(73) Assignee: HEWLETT-PACKARD DEVELOPMENT COMPANY, L.P., Spring, TX (US)

(21) Appl. No.: 17/778,574

(22) PCT Filed: Dec. 12, 2019
(86) PCT No.: PCT/US2019/065944

§ 371 Date: May 20, 2022

(51) Int. Cl. G06T 7/20

(52) U.S. Cl. CPC G06T 7/20; G06T 2207/10016; G06T 2207/10056

(57) ABSTRACT

In example implementations, an apparatus is provided. The apparatus includes a channel, a camera, and a processor. The channel contains a fluid and an object. The fluid is to move the object through the channel. The camera system is to capture video images of the object in the channel. The processor is to track movement of the object in the channel via the video images based on known flow dynamics of the channel.

### BACKGROUND

Certain industries may track objects within a fluidic channel for a variety of different reasons. The objects can be tracked inside the fluidic channel for observing properties of the objects, sorting objects in the fluidic channel, studying fluid flow around the objects, classification, and the like.

### BRIEF DESCRIPTION OF THE DRAWINGS

FIG. 1 is a block diagram of an example system to provide object tracking based on known flow dynamics of a flow field of the present disclosure;

FIG. 2 is an example process flow of object tracking based on known flow dynamics of a flow field of the present disclosure;

FIG. 3 is an example of another process flow of object tracking based on known flow dynamics of a flow field of the present disclosure;

FIG. 4 is an example of another process flow of object tracking based on known flow dynamics of a flow field of the present disclosure;

FIG. 5 a flow chart of an example method for tracking an object in a flow field based on known flow dynamics of the flow field; and

FIG. 6 is a block diagram of an example non-transitory computer readable storage medium storing instructions executed by a processor to track an object in a flow field based on known flow dynamics of the flow field.

### DETAILED DESCRIPTION

Examples described herein provide a system and apparatus for tracking objects in a flow field based on known flow dynamics of a flow field. As noted above, certain industries may track objects within a fluidic channel for a variety of different reasons. The objects can be tracked inside the fluidic channel for observing properties of the objects, sorting objects in the fluidic channel, studying fluid flow around the objects, classification, and the like.

For example, the objects may be cells or particles that are injected into a fluidic channel. Some systems for tracking the objects in the channel may use historical data to estimate the movement of the objects. Based on the historical data, an example system could try to predict where the objects would be to track the movement of the objects.

However, these example systems may suffer from issues of initialization and failures. For example, when the example system detects an object for the first time, there is no prior information to use to initialize a velocity of the object, and the systems may rely on random guesses taken from a uniform distribution for the initialization. Also, the example systems may fail when the object is occluded or cannot be detected.

Examples herein provide a system and method that uses known flow dynamics of a flow field to predict the movement of objects within the flow field. For example, based on a location of the object within the flow field, the system may predict the movement of the object (e.g., direction and velocity) and predict where the object may be located in a subsequent video frame. The known flow dynamics of the flow field may be used in conjunction with other example tracking methods to improve overall object tracking within the flow field.

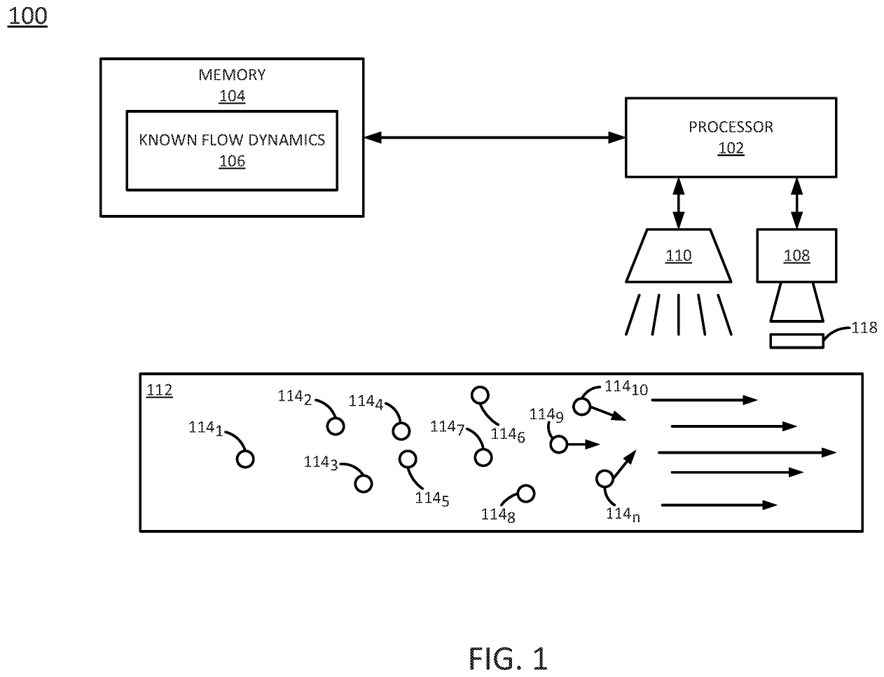

FIG. 1 illustrates an example block diagram of an apparatus 100 of the present disclosure. In one example, the apparatus 100 may include a processor 102 communicatively coupled to a memory 104, a camera 108, and a light source 110. The processor 102 may control operation of the light source 110 and the camera 108.

In one example, the light source 110 may be any type of light source to illuminate a portion of a flow field 112 where the camera 108 may be capturing images. The flow field 112 may be any type of volume that includes any type of fluid flow. For example, the flow field 112 may be a channel that has a flowing fluid that includes objects 114₁ to 114ₙ (also referred to herein individually as an object 114 or collectively as objects 114). In an example, the amount of light emitted by the light source 110 may be varied to allow the camera 108 to capture video images of different depths within the flow field 112.

In one example, the camera 108 may be a red, green, blue (RGB) video camera that can capture video images. The video images may include consecutive frames of video that can be analyzed to track movement of the objects 114 within the flow field 112. The objects 114 may be biological cells, molecules, particles, or any other type of object that is being studied, counted, sorted, and the like, within a fluidic channel or flow field. In an example, the objects 114 may be auto-luminescent (e.g., chemi-luminescence).

In one example, the camera 108 may be a depth sensing camera. Thus, the camera 108 may capture video images of a single plane within the flow field 112 or a plurality of planes within the flow field 112.

In one example, the camera 108 may include an optical lens 118. The optical lens 118 may be a magnifying glass or microscope to provide magnification of the video images. The magnification may allow the objects 114 to appear larger and more detailed within the video images captured by the camera 108.

In one example, the memory 104 may be a non-transitory computer readable medium. For example, the memory 104 may be a hard disk drive, a random access memory, a read only memory, a solid state drive, and the like. The memory 104 may store various types of information or instructions that are executed by the processor 102. For example, the instructions may be associated with functions performed by the processor 102 to track objects 114 within a flow field 112, as discussed in further details below.

In an example, the memory 104 may store known flow dynamics 106. The known flow dynamics 106 may be used by the processor 102 to predict where an object 114 is moving within the flow field 112 based on a current location within the flow field 112. In other words, without any previous data or any a priori knowledge of the movement of the objects 114, the processor 102 may predict where the object 114 may be based on the known flow dynamics 106.

In one example, the known flow dynamics 106 may also be a function of characteristics of the object 114. For example, different sized particles and different shaped particles may move at different velocities and in different directions at the same location within the flow field 112.

In an example, the known flow dynamics 106 may be a function, or a physical model, that provides an estimated velocity and direction at a particular location within the flow field 112. The location may be measured as a shortest distance from a wall of the flow field 112. The locations may be within a particular portion or field of view of the flow field 112 that can be captured by the camera 108.

In an example, the function may account for the characteristics of the objects 114. Different functions may be determined as the function may vary based on the properties (e.g., diameter, shape, type of material lining the flow field 112, smoothness of the inner walls of the flow field 112, amount of fluid in the flow field 112, and so forth) of the flow field 112.

In another example, the known flow dynamics 106 may be a look up table that provides an estimated velocity and direction at various locations within the flow field 112. The properties of different objects 114 may also be considered in the look up table.

In an example, the known flow dynamics 106 may be established before the objects 114 are injected into the flow field 112. The flow field 112 may be built by a person who is studying the objects 114 within the flow field 112. Thus, the characteristics of the flow field 112 may be known. In another example, the characteristics of the flow field 112 may be determined based on controlled trials.

In one example, the flow field 112 may be a fluidic channel that contains a fluid. The objects 114 may be moved within the flow field 112 by the flow of the fluid within the flow field 112. In one example, flow field 112 may be part of a larger chip that can be used to study the objects 114, count the objects 114, sort the objects 114, and the like.

In one example, the camera 108 may capture video images of the movement of the objects 114 within the flow field 112. The video images may be analyzed to track the movement of the objects 114. The movement of the objects 114 determined by the captured images can be compared to the predicted movement of the objects 114 determined based on the known flow dynamics 106 to update the known flow dynamics 106.

For example, the known flow dynamics 106 may predict that an object 114 at a particular location may move in a parallel direction at 1 nanometer per second (nm/s). However, the actual movement based on an analysis of the video images may determine that the object 114 moves at a slight angle of 1 degree above the parallel direction at 1.1 nm/s. Thus, the known flow dynamics 106 may be updated with the updated information. Over time, the known flow dynamics 106 may become more accurate.

In one example, the known flow dynamics 106 may also help to improve the processing of video images to track movement of the objects 114. For example, in a first video frame of the video images, an object 114 may be selected for tracking (e.g., the object 114ₙ). Based on the location of the object 114ₙ within the flow field 112, the processor 102 may use the known flow dynamics 106 to predict where the object 114ₙ may be in a subsequent time frame.

For example, based on the elapsed time between video frames, the predicted velocity and direction of the object 114ₙ, the processor 102 may estimate where the object 114ₙ may be in a second video frame. Thus, the processor 102 may reduce a search for the object 114ₙ to within a smaller area of the video frame based on where the object 114ₙ should be located. Particle characteristics observed in the first video frame may be used to confirm that the correct object 114ₙ is identified in the second video frame. Thus, the known flow dynamics 106 may allow the processor 102 to analyze smaller areas of subsequent video frames of a video image to track the object 114ₙ rather than having to analyze the entire video frame.

In addition, the known flow dynamics 106 may also allow predictions regarding movement of the objects 114 to be made beginning with the first video frame. For example, in other example methods, without previous particle movement data no predictions could be made, or less accurate guesses regarding the movement could be used. For example, if a particle was in a location with no previous data, other example methods may not be able to accurately predict or track the movement of the particle. However, in the present disclosure, the known flow dynamics 106 may model the velocity and direction of particles in any location within the flow field 112. Thus, accurate predictions regarding movement of the objects 114 can be made from the first video frame even without any previous particle movement data at a particular location within the flow field 112.

Lastly, the known flow dynamics 106 may be combined with currently used methods to improve the accuracy of the currently used methods. For example, certain methods may perform estimation for particle tracking that converge over several iterations to a solution. The known flow dynamics 106 may help provide accurate predictions of where the particles should be to help the convergence of some methods occur more quickly.

Thus, the apparatus 100 of the present disclosure may provide more efficient and accurate tracking of the objects 114. The accurate tracking of the objects 114 may allow an observer to follow movement of the objects 114 within the flow field 112 for various applications. For example, accurate tracking may provide for an accurate count of the number of objects 114. In another example, accurate tracking may allow an observer to know that the objects 114 are properly sorted for sorting applications. In another example, accurate tracking may allow an observer to obtain certain characteristics of the particle (e.g., movement speeds, movement characteristics, and the like) based on the particle characteristics.

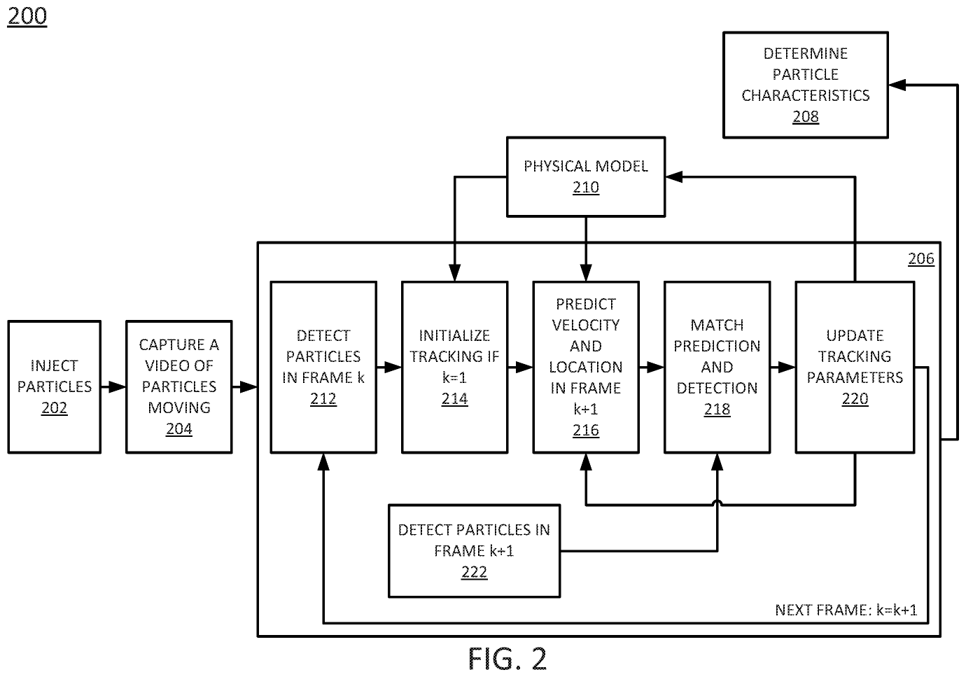

FIG. 2 illustrates an example process flow 200 of object tracking based on the known flow dynamics of a flow field of the present disclosure. In one example, at block 202 particles or objects may be injected into a fluidic channel or flow field. The particles may be injected for the first time into the fluidic channel with no prior data on the objects within the fluidic channel. In other words, there is no historical data with respect to how the particles may move within the fluidic channel.

At block 204 a camera may capture a video of particles that are moving within the fluidic channel. The camera may capture a layer or plane within the fluidic channel or may capture multiple planes within the fluidic channel (e.g., with a depth sensing camera).

At block 206, the video images may be analyzed to track movement of the particles. At block 208, particle characteristics may be determined and output based on the tracking performed within the block 206. The particle characteristics may include a desired output based on the observation of the particle tracking. For example, the characteristics may include a count of certain particles, sorting the particles, how certain properties of the particles affect how the particles move within the fluidic channel, and the like.

Within the block 206, the process flow 200 may include additional blocks to track movement of the particles. For example, at block 212, a particle or particles that will be tracked may be detected in frame k. At block 214, if k=1, then the tracking process may be initialized with a physical model from block 210. The physical model in block 210 may be a function or look up table that is determined from the known flow dynamics 106 of the fluidic flow field 112, as described above.

At block 216, the process flow 200 may predict a velocity and location in a subsequent frame (e.g., frame k+1) of the video images that are captured by the camera. In one example, the velocity may be a vector that includes speed and direction. The prediction may be based on the physical model from the block 210. For example, based on a particular location of a particle within the fluidic channel, the physical model may predict where the particle should move to a later time associated with the subsequent frame (e.g., frame k+1).

In parallel, at block 222 the process flow 200 may detect the same particle in the subsequent frame k+1 by analyzing the video images. For example, a detected particle in the block 212 may be identified based on certain particle characteristics (e.g., size, shape, color, and the like) in the frame k and subsequent frame k+1.

At block 218, the process flow 200 may match the prediction from the block 216 and the detection from the block 222. In other words, the block 218 may compare the prediction performed in the block 216 to the actual detection performed in the block 222 to determine whether the outputs match.

Based on the match or comparison performed at block 218, at block 220 the tracking parameters may be updated. For example, if the prediction of the location of the particle in the subsequent frame k+1 does not match the actual determination of where the particle is located in block 222, then tracking parameters may be updated. For example, the physical model may predict in the block 216 that a particle moves in a particular direction at a particular speed. However, the determination at block 222 shows that the particle moved in an actual direction at an actual speed. The tracking parameters that are updated in the block 220 may then be fed to the physical model 210.

The physical model 210 may be adjusted to account for the updated tracking parameters from the block 220. As a result, on a subsequent run of the process flow 200 on another injection of particles, the physical model 210 may provide a more accurate prediction in the block 216. After the tracking parameters are updated (or not updated if the prediction and determination match), the process flow 200 may determine the particle characteristics at block 208, as noted above.

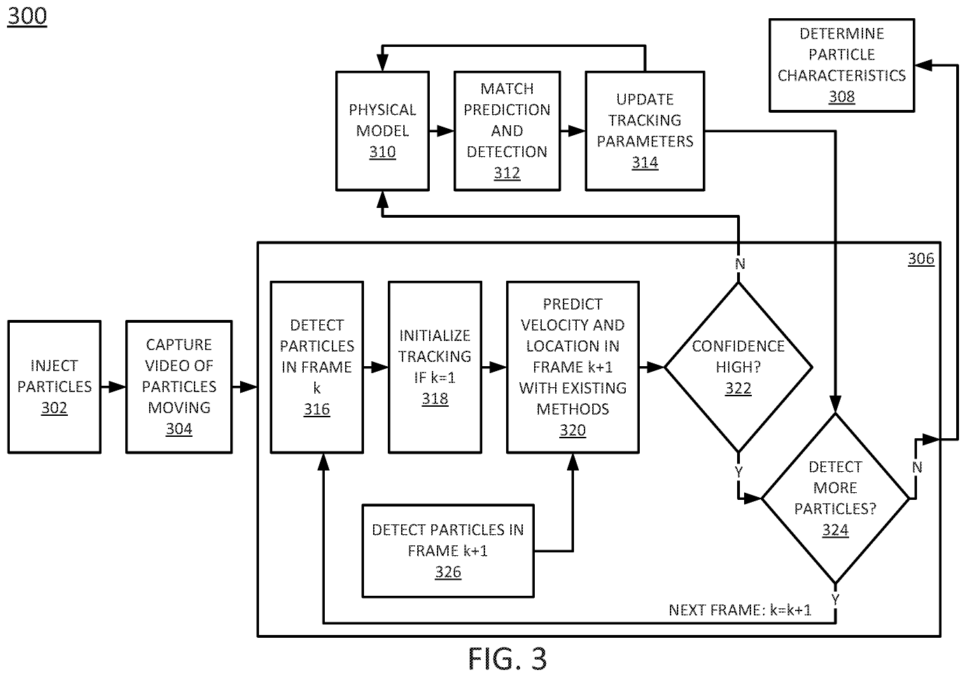

FIG. 3 illustrates an example of a process flow 300 of object tracking based on the known flow dynamics of a flow field of the present disclosure. In one example, at block 302 particles or objects may be injected into a flow field. The particles may be injected for the first time into the flow field with no prior data on the objects within the flow field. In other words, there is no historical data with respect to how the particles may move within the flow field.

At block 304 a camera may capture a video of particles that are moving within the flow field. The camera may capture a layer or plane within the flow field or may capture multiple planes within the flow field (e.g., with a depth sensing camera).

At block 306, the video images may be analyzed to track movement of the particles. At block 308, particle characteristics may be determined and output based on the tracking performed within the block 306. The particle characteristics may include a desired output based on the observation of the particle tracking. For example, the characteristics may include a count of certain particles, sorting the particles, how certain properties of the particles affect how the particle moves within the flow field, and the like.

Within the block 306, the process flow 300 may include additional blocks to track movement of the particles. For example, at block 316, a particle or particles that will be tracked may be detected in frame k. At block 318, if k=1, then the tracking process may be initialized with a physical model from block 310. The physical model in block 310 may be a function or look up table that is determined from the known flow dynamics 106 of the flow field 112, as described above.

At block 320, the process flow 300 may predict a velocity and location in a subsequent frame (e.g., frame k+1) of the video images that are captured by the camera. In one example, the velocity may be a vector that includes speed and direction. The prediction may be based on existing methods or processes (e.g., Kalman filter, Median Flow tracker, and the like).

In parallel, at block 326 the process flow 300 may detect the same particle in the subsequent frame k+1 by analyzing the video images. For example, a detected particle in the block 316 may be identified based on certain particle characteristics (e.g., size, shape, color, and the like) in the frame k and subsequent frame k+1.

At block 322, the process flow 300 may determine a confidence level of the prediction made at block 320 compared to the detection of the particles in the subsequent frame k+1 in the block 326. In one example, the confidence level may be scored based on how close the prediction was to the determined location. In one example, the confidence level may be a percentage based on how close the prediction in the block 320 was to the detection made in the block 326. In one example, if the confidence level is above a threshold, the confidence may be high and the process flow 300 may proceed to block 324. For example, the threshold may be greater than 90% confidence, or any other desired threshold value.

At block 324 if there are more particles to detect and track, the process flow 300 may return to block 316 and proceed to the next frame k+1. In other words, the frame k in block 316 may now be frame k+1 and the subsequent frame may be k+2. And the analysis of the video images in the block 306 may be repeated until all of the particles are tracked. If there are no more particles to detect and track, the process flow 300 may proceed to the block 308 to determine particle characteristics, as noted above.

Returning back to the block 322, if the confidence is not high (e.g., below a threshold value of 90% or any other desired threshold value), then the process flow 300 may proceed to block 310. At block 310, the physical model may be used to predict where the particle may be located in the subsequent frame k+1.

The prediction by the physical model and the detection performed in the block 326 may be matched at block 312. Based on the match or comparison in the block 312, the tracking parameters may be updated in block 314. For example, any differences between the prediction and the detection in the block 312 may be used to update the tracking parameters. The updated tracking parameters may then be fed back to the physical model in the block 310 to modify or adjust the physical model. The process flow 300 may then proceed to the block 324.

Thus, the physical model in the process flow 300 may be used to supplement existing methods. For example, when an existing method fails (e.g., due to occlusion of a particle in the image) or inaccurately predicts the movement (e.g., the particle is in a location within the flow field that has no historical data), the physical model derived from the known flow dynamics 106 can be used to supplement the existing method.

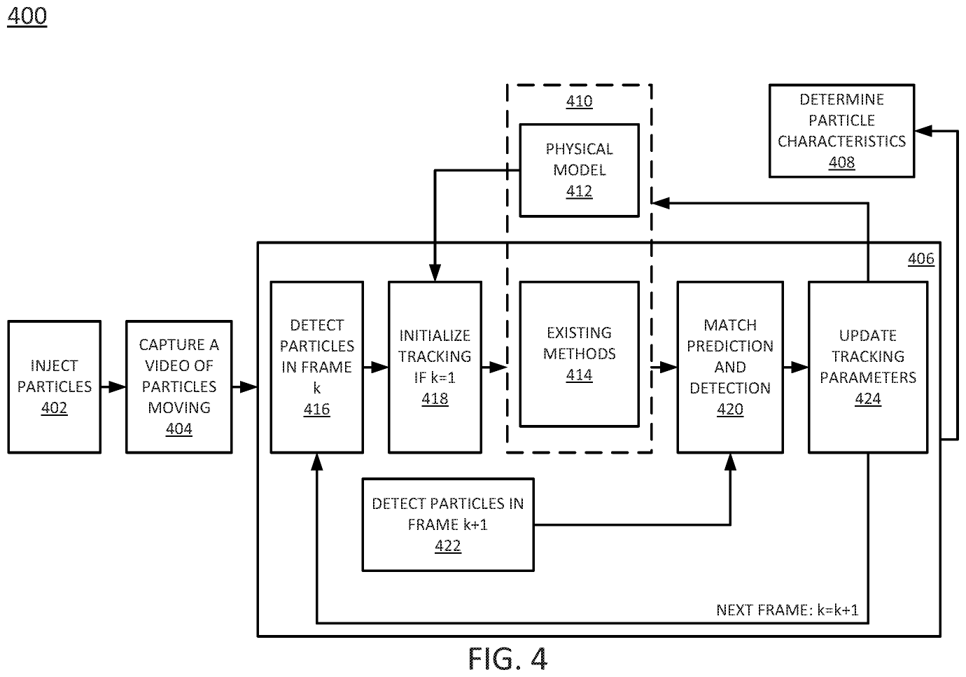

FIG. 4 illustrates an example process flow 400 of object tracking based on the known flow dynamics of a flow field of the present disclosure. In one example, at block 402 particles or objects may be injected into a flow field. The particles may be injected for the first time into the flow field with no prior data on the objects within the flow field. In other words, there is no historical data with respect to how the particles may move within the flow field.

At block 404 a camera may capture a video of particles that are moving within the flow field. The camera may capture a layer or plane within the flow field or may capture multiple planes within the flow field (e.g., with a depth sensing camera).

At block 406, the video images may be analyzed to track movement of the particles. At block 408, particle characteristics may be determined and output based on the tracking performed within the block 406. The particle characteristics may include a desired output based on the observation of the particle tracking. For example, the characteristics may include a count of certain particles, sorting the particles, how certain properties of the particles affect how the particle moves within the flow field, and the like.

Within the block 406, the process flow 400 may include additional blocks to track movement of the particles. For example, at block 416, a particle or particles that will be tracked may be detected in frame k. At block 418, if k=1, then the tracking process may be initialized with a physical model from a hybrid model 410 that includes a combination of the physical model in block 412 and an existing tracking method 414. The physical model in block 412 may be a function or look up table that is determined from the known flow dynamics 106 of the flow field 112, as described above.

At block 410, the process flow 200 may predict a velocity and location in a subsequent frame (e.g., frame k+1) of the video images that are captured by the camera. In one example, the velocity may be a vector that includes speed and direction. The prediction may be based on the physical model from the block 412 and the existing tracking method 414.

For example, some existing tracking methods may use a relaxation function where each particle in a current video frame preselects its candidate partners in the next frame within a certain distance threshold. Then a matching probability is assigned to each candidate and potentially no match. The probability then evolves after a few iterations to reach an optimized value. The physical model 412 may be used to initialize this probability to help the existing tracking method 414 to converge faster.

In parallel, at block 422 the process flow 400 may detect the same particle in the subsequent frame k+1 by analyzing the video images. For example, a detected particle in the block 422 may be identified based on certain particle characteristics (e.g., size, shape, color, and the like) in the frame k and subsequent frame k+1.

At block 420, the process flow 400 may match the prediction from the block 410 and the detection from the block 422. In other words, the block 420 may compare the prediction performed in the block 410 to the actual detection performed in the block 422 to determine whether the outputs match.

Based on the match or comparison performed at block 420, at block 424 the tracking parameters may be updated. For example, if the prediction of the location of the particle in the subsequent frame k+1 does not match the actual determination of where the particle is located in block 422, then the tracking parameters may be updated. For example, the hybrid model may predict in the block 410 that a particle moves in a particular direction at a particular speed. However, the determination at block 422 shows that the particle moved in an actual direction at an actual speed. The tracking parameters that are updated in the block 424 may then be fed to the physical model 412.

The physical model 412 may be adjusted to account for the updated tracking parameters from the block 424. As a result, on a subsequent run of the process flow 400 on another injection of particles, the physical model 412 may provide a more accurate prediction in the block 410 when used with the existing tracking method 414. After the tracking parameters are updated (or not updated if the prediction and determination match), the process flow 400 may determine the particle characteristics at block 408, as noted above.

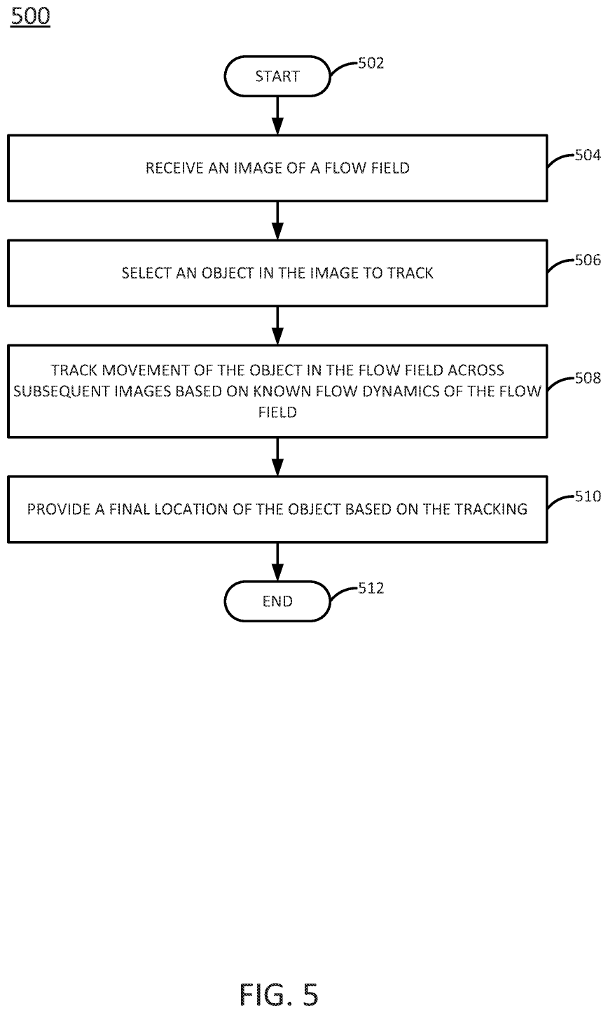

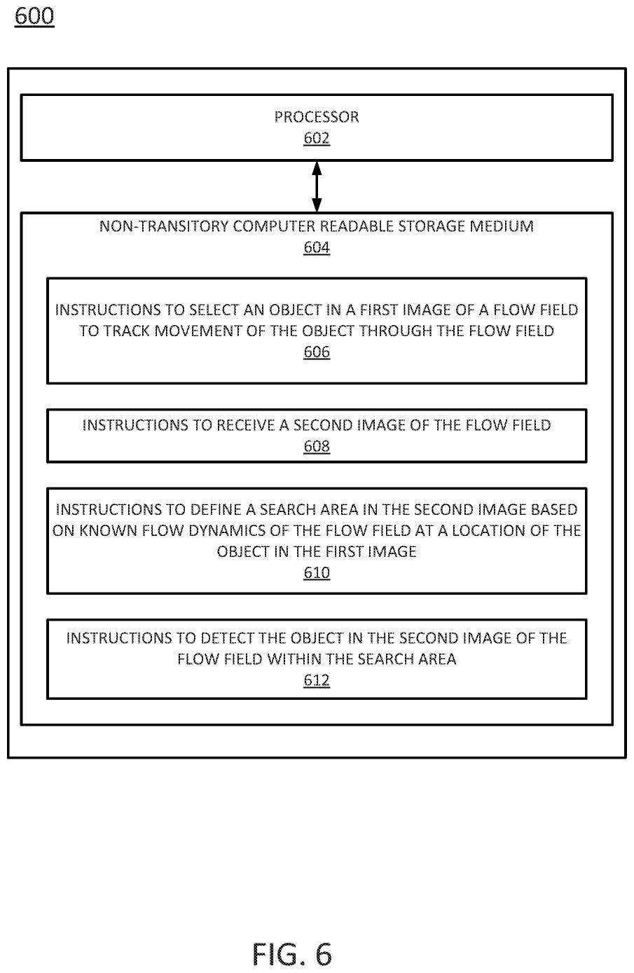

FIG. 5 illustrates a flow diagram of an example method 500 for tracking an object in a flow field based on known flow dynamics of the flow field of the present disclosure. In an example, the method 500 may be performed by the apparatus 100 or the apparatus 600 illustrated in FIG. 6 and described below.

At block 502, the method 500 begins. At block 504, the method 500 receives an image of a flow field. For example, the image may be a video image that comprises a plurality of video frames. The video image may be of a single plane within the flow field or a plurality of planes within the flow field.

At block 506, the method 500 selects an object in the image to track. For example, the flow field may be injected with objects (e.g., biological cells, particles, molecules, and the like). A particular object or a plurality of objects within the flow field may be selected for tracking. In one example, the properties or characteristics of the object that is selected may be recorded such that the same object can be identified for tracking in a subsequent video frame.

At block 508, the method 500 tracks movement of the object in the flow field across subsequent images based on known flow dynamics of the flow field. For example, the known flow dynamics may provide a physical model of the flow field. The physical model may be a function or a look up table that provides a velocity and direction of an object at a particular location within the flow field. In the first video frame, the location of the selected object may be determined. Based on a frame rate of the video images and the location of the selected object, the known flow dynamics of the flow field may predict where the selected object should be in the subsequent video frame.

In one example, the prediction may be used to reduce an amount of the subsequent video frame that is processed or analyzed. For example, a predefined area (e.g., a radius of several pixels, millimeters, inches, and the like) around the predicted location of the selected object may be included for analysis. In other word, rather than processing the entire subsequent video frame, a smaller area can be processed to detect where the selected object is located.

In one example, if the predicted location is different than the detected location, the known flow dynamics may be updated based on the comparison. For example, function may be modified to account for the actual velocity and direction of movement from a particular location within the flow field. In another example, the velocity and direction at a particular location within the flow field for a particular object may be updated in a look up table based on the known flow dynamics.

At block 510, the method 500 provides a final location of the object based on the tracking. In one example, the blocks 504-510 may be repeated until tracking of the object is completed or no more video frames remain for a video image. The desired output based on the tracking of the object may then be produced. For example, the output may be a count of a particular object based on the tracking, sorting the object, observing how the object may react to certain flow, deformation, disease, and the like, within the flow field, how fluids may flow around a particular object moving inside of the flow field, and so forth. At block 512, the method 500 ends.

FIG. 6 illustrates an example of an apparatus 600. In an example, the apparatus 600 may be the computing device 102. In an example, the apparatus 600 may include a processor 602 and a non-transitory computer readable storage medium 604. The non-transitory computer readable storage medium 604 may include instructions 606, 608, 610, and 612 that, when executed by the processor 602, cause the processor 602 to perform various functions.

In an example, the instructions 606 may include instructions to select an object in a first image of a flow field to track movement of the object through the flow field. The instructions 608 may include instructions to receive a second image of the flow field. The instructions 610 may include instructions to define a search area in the second image based on known flow dynamics of the flow field at a location of the object in the first image. The instructions 612 may include instructions to detect the object in the second image of the flow field within the search area.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a channel containing a fluid and an object, wherein the fluid is to move the object through the channel;
a camera system to capture video images of the object in the channel; and
a processor to track movement of the object in the channel via the video images based on known flow dynamics of the channel.

2. The apparatus of claim 1, further comprising:
a light source to illuminate the channel.

3. The apparatus of claim 1, wherein the camera system comprises a microscope to magnify the video images of the channel.

4. The apparatus of claim 1, wherein the known flow dynamics comprises a velocity and a direction of a plurality of different locations within the channel.

5. The apparatus of claim 4, wherein the processor is to track movement of the object in the channel by searching an area of the video images based on the known flow dynamics of a location of the object in a previous video image of the video images.

6. The apparatus of claim 1, wherein the video images are of a single plane within the channel or a plurality of planes within the channel.

7. A method, comprising:
receiving, by a processor, an image of a flow field;
selecting, by the processor, an object in the image to track;
tracking, by the processor, movement of the object in the flow field across subsequent images based on known flow dynamics of the flow field; and
providing, by the processor, a final location of the object based on the tracking.

8. The method of claim 7, wherein the tracking comprises:
determining, by the processor, a particular area of a subsequent image to search for the object based on the known flow dynamics of the flow field at a location of the object in the image.

9. The method of claim 8, further comprising:
comparing, by the processor, a detected location of the object in the subsequent image to a predicted location based on the known flow dynamics of the flow field; and
updating, by the processor, the known flow dynamics of the flow field based on the comparing.

10. The method of claim 7, wherein the tracking is performed in response to failure of a tracking method based on historical data.

11. The method of claim 7, wherein the tracking is performed in combination with a tracking method based on historical data.

12. The method of claim 7, wherein the flow dynamics comprises a velocity and a direction at different locations in the flow field.

13. A non-transitory computer readable storage medium encoded with instructions executable by a processor, the non-transitory computer-readable storage medium comprising:
instructions to select an object in a first image of a flow field to track movement of the object through the flow field;
instructions to receive a second image of the flow field;
instructions to define a search area in the second image based on known flow dynamics of the flow field at a location of the object in the first image; and
instructions to detect the object in the second image of the flow field within the search area.

14. The non-transitory computer readable storage medium of claim 13, wherein the instructions to define the search area and the instructions to detect the object are repeated for subsequently received images to track the movement of the object through the flow field.

15. The non-transitory computer readable storage medium of claim 13, wherein the instructions to detect are based on a match of at least one characteristic of the object in the first image and the second image.
